(19) United States
(12) Patent Application Publication
(10) Pub. No.: US 2026/0180264 A1
(43) Pub. Date: Jun. 25, 2026

(54) ROUTING MODULE AND CONNECTOR

(71) Applicant: Yazaki Corporation, Tokyo (JP)

(72) Inventors: Masayoshi TAKAYANAGI, Shizuoka (JP); Sadaharu OKUDA, Shizuoka (JP); Hikaru SANO, Shizuoka (JP); Koki ADACHI, Shizuoka (JP); Ryoichi MURATA, Shizuoka (JP); Takaaki YUASA, Shizuoka (JP)

(73) Assignee: Yazaki Corporation, Tokyo (JP)

(21) Appl. No.: 19/430,560

(22) Filed: Dec. 23, 2025

(30) Foreign Application Priority Data
Dec. 24, 2024 (JP) 2024-227704

(51) Int. Cl. H01R 13/73

(52) U.S. Cl. CPC H01R 13/73

(57) ABSTRACT

A routing module includes a routing member electrically connected to an electrode terminal of a battery cell forming a battery module, a routing module case having a routing path formed for the routing member to be provided therein, and a connector including a housing fixed from one side of a height direction which is a direction orthogonal to and intersecting a fitting direction in which one end of the routing member is fitted to a connector of a monitoring device serving as a mating connector, in which the routing member extends toward one side of the housing, and the pressing member is provided on one side of the housing via a hinge.

### CROSS-REFERENCE TO RELATED APPLICATION(S)

The present application claims priority to and incorporates by reference the entire contents of Japanese Patent Application No. 2024-227704 filed in Japan on Dec. 24, 2024.

### BACKGROUND OF THE INVENTION

### 1. Field of the Invention

The present invention relates to a routing module and a connector.

### 2. Description of the Related Art

As a technique related to a conventional routing module and connector, for example, JP 2019-192 336 A discloses a routing module including a flat cable attached to an energy storage element group in which a plurality of energy storage elements are integrated, and a cable side connector connected to an end portion of the flat cable and fitted to a device side connector provided in a control unit of the energy storage element group. The flat cable has an extra length portion extending from the energy storage element group, and a bend restricting plate is stacked on a part of the extra length portion. The bend restricting plate suppresses free movement of the extra length portion due to vibration or the like.

In such a routing module and connector, for example, the arrangement of an extra length portion of a routing member may be set in consideration of the arrangement of peripheral components such as a cover of a battery pack, but there is room for further improvement in the arrangement of the extra length portion of the routing member.

### SUMMARY OF THE INVENTION

The present invention has been made in view of the above-described circumstances, and an object thereof is to provide a routing module and a connector capable of appropriately arranging an extra length portion of a routing member.

In order to achieve the above mentioned object, a routing module according to one aspect of the present invention includes a routing member electrically connected to an electrode terminal of a battery cell forming a battery module; a routing module case having a routing path formed for the routing member to be provided therein; and a connector including a housing fixed from one side of a direction intersecting a fitting direction in which one end of the routing member is fitted to a mating connector, wherein the routing member extends toward the one side of the housing, and a pressing member is provided on the one side of the housing via a hinge.

In order to achieve the above mentioned object, a connector according to another aspect of the present invention includes a housing fixed to one side of a direction intersecting a fitting direction in which one end of a routing member electrically connected to an electrode terminal of a battery cell forming a battery module is fitted to a mating connector; and a pressing member provided on the one side of the housing via a hinge.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view illustrating a schematic configuration in a state in which a routing module including a connector according to an embodiment is assembled with a battery module; and

FIG. 2 is a front view illustrating a schematic configuration in a state in which the routing module including the connector according to the embodiment is assembled with the battery module and in a state in which the connector is fitted to a mating connector.

### DETAILED DESCRIPTION OF THE PREFERRED EMBODIMENTS

Hereinafter, an embodiment according to the present invention will be described in detail with reference to the drawings. It is noted that the present invention is not limited by the embodiment. In addition, components in the following embodiment include those that can be easily replaced by those skilled in the art or those that are substantially the same.

### Embodiment

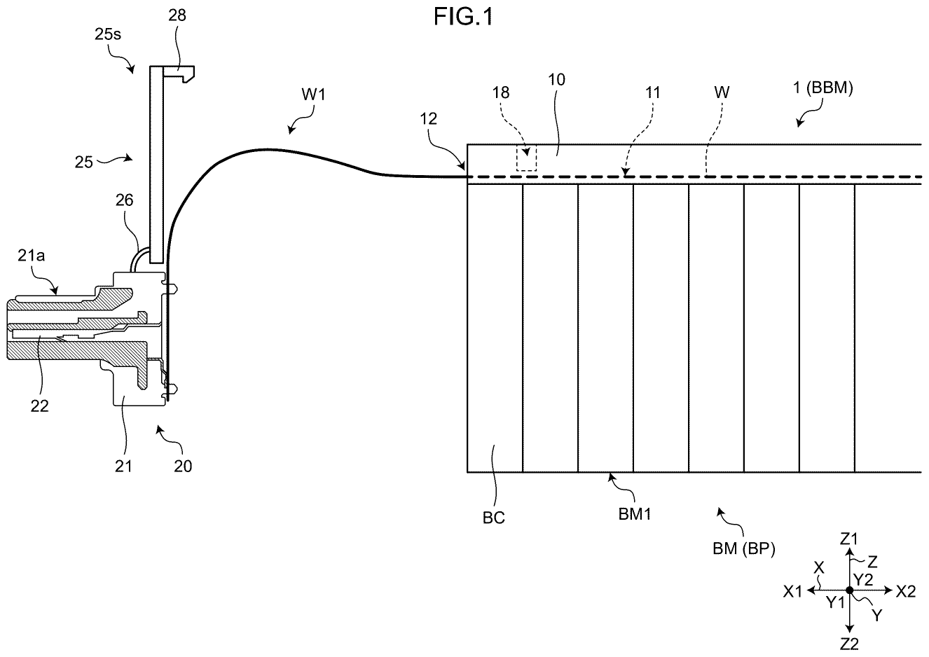

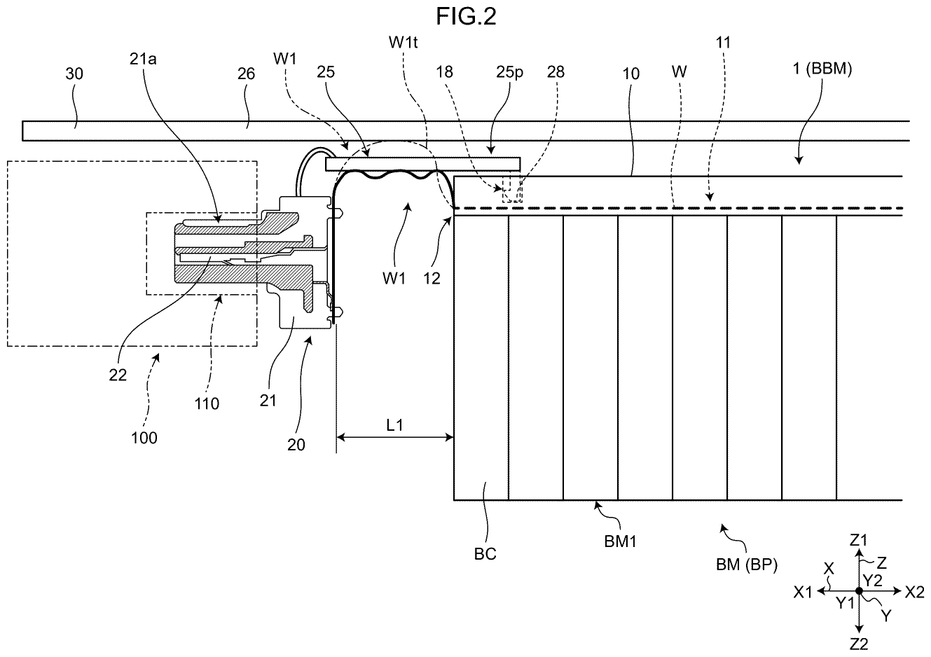

A routing module 1 of the present embodiment illustrated in FIGS. 1 and 2 is included in a busbar module BBM assembled with a battery module BM. The routing module 1 includes a routing module case 10, a routing member W, and a connector 20. The plurality of battery cells BC form the battery module BM. The battery module BM is a component of a battery pack BP. The battery pack BP may have a plurality of battery modules BM. For example, the battery pack BP is mounted as a power source in a vehicle such as an electric vehicle or a hybrid electric vehicle.

The busbar module BBM accommodates a plurality of busbars (not illustrated) electrically connected to a pair of electrodes (not illustrated) including a positive electrode terminal and a negative electrode terminal in each battery cell BC. The pair of electrodes of the plurality of battery cells BC is connected in parallel or in series by a plurality of busbars. An electrode terminal of each battery cell BC is electrically connected to the routing member W via, for example, a voltage detection terminal (not illustrated). The voltage detection terminal is electrically connected to, for example, the busbar, and detects a voltage between the electrode terminals. The routing member W electrically connected to the voltage detection terminal is electrically connected to a monitoring device 100 (refer to FIG. 2) via the connector 20. The connector 20 is formed as a female connector and is fitted to a connector 110 (a mating connector) of the monitoring device 100 formed as a male connector. The voltage of each battery cell BC is monitored by the monitoring device 100.

In the following description, a direction in which the connector 20 is fitted to the connector 110 of the monitoring device 100 is referred to as a fitting direction X, and two directions that are orthogonal to and intersect the fitting direction X are referred to as a width direction Y and a height direction Z. The height direction Z is a direction perpendicular to an installation surface BM1 of the battery module BM. In the following description, one side of the fitting direction X is referred to as one side X1, and the other side thereof is referred to as the other side X2. Similarly, a description will be made on the assumption that one side of the width direction Y is referred to as one side Y1 (front side of the paper surface in FIGS. 1 and 2) and the other side thereof is referred to as the other side Y2 (rear side of the paper surface in FIGS. 1 and 2), and one side of the height direction Z is referred to as one side Z1 and the other side thereof is referred to as the other side Z2.

Although not illustrated, positive and negative electrode terminals of the battery cell BC are arranged, for example, on one side Z1 of the height direction Z in the battery cell BC, one electrode terminal is provided on one side Y1 of the width direction Y, and the other electrode terminal is provided on the other side Y2 thereof. The busbar module BBM extends along the fitting direction X and is assembled with one side Z1 of the height direction Z in the battery module BM. The routing module 1 of the busbar module BBM includes the routing module case 10. The routing module case 10 has a routing path 11 through which the routing member W is routed.

The routing member W extends in a direction along the fitting direction X and is, for example, a flat routing member such as a flexible printed circuit (FPC) or a flexible flat cable (FFC). When the routing member W is an FPC, the routing member W includes a base film, a coverlay, and a conductive layer. The base film and the coverlay are flexible insulating resin layers. The conductive layer is sandwiched between and protected by the base film and the coverlay. The conductive layer is, for example, a conductive metal foil, and has a plurality of circuit patterns electrically connected to the above-described bus bar (not illustrated) via the voltage detection terminal.

The routing path 11 through which the routing member W is routed extends along the fitting direction X. The routing path 11 is provided, for example, between the electrode terminals of the positive electrode and the negative electrode in the width direction Y of the plurality of battery cells BC, and is formed to have a substantially recessed groove shape. In the present embodiment, the routing member W serving as a flat routing member is routed with the flat surface oriented in the height direction Z. The routing member W is routed in the routing path 11 along a direction in which the routing path 11 extends (that is, the fitting direction X). One end of the routing member W, that is, one side X1 of the fitting direction X in the routing member W extends toward the outside from one side X1 of the fitting direction X in the routing module case 10. More specifically, an outlet portion 12 opened or the like and formed for the routing member W to protrude and extend toward one side X1 is provided in an end portion of the routing module case 10 on one side X1 of the fitting direction X. The routing member W extends from the outlet portion 12 toward the outside on one side X1 of the fitting direction X.

Meanwhile, the connector 20 includes a housing 21 forming a casing of the connector 20, a plurality of terminals 22, and a pressing member 25. The housing 21 of the connector 20 is formed to have a substantially rectangular box shape extending in the width direction Y. One side X1 of the fitting direction X in the housing 21 is formed to have a substantially rectangular tubular shape extending in the width direction Y, and is a terminal holding portion 21a that holds the plurality of terminals 22. In the terminal holding portion 21a, the plurality of terminals 22 are arranged and held in the width direction Y. Here, the connector 110 of the monitoring device 100 illustrated in FIG. 2 is provided with a terminal (not illustrated) serving as a male terminal. The terminal of the connector 110 is held by a substantially rectangular tubular-shaped hood portion (not illustrated) that is formed in the connector 110 and extends in the width direction Y. The terminal holding portion 21a of the connector 20 is inserted into the hood portion in the connector 110 of the monitoring device 100 along the fitting direction X. When the terminal holding portion 21a is inserted into the hood portion of the connector 110, the terminal 22 of the connector 20 serving as the female terminal and the terminal of the connector 110 of the monitoring device 100 serving as the male terminal are fitted and electrically connected to each other.

One end of the routing member W (an end portion of the routing member W on one side X1 of the fitting direction X) is fixed to the other side X2 of the fitting direction X in the housing 21 of the connector 20. The routing member W is fixed to the housing 21 by, for example, a fixing member such as a peg for fixing the routing member W to the housing 21. By fixing the routing member W to the housing 21 of the connector 20, the plurality of terminals 22 of the connector 20 are electrically connected to the routing member W.

The routing member W is fixed from one side Z1 of the height direction Z in the housing 21 of the connector 20. Therefore, in the housing 21, the routing member W extends toward one side Z1 of the height direction Z.

In the housing 21, the pressing member 25 is provided on one side Z1 of the height direction Z in the housing 21 with a hinge 26 interposed therebetween. The pressing member 25 is formed to have a substantially long rectangular plate shape that extends toward one side Z1 of the height direction Z in FIG. 1. The hinge 26 is formed to have a substantially thin plate shape. In FIG. 1, one end of the substantially thin plate-shaped hinge 26 is connected to an end portion of the pressing member 25 on the other side Z2 of the height direction Z, and the other end thereof is connected to a surface of the housing 21 on one side Z1 of the height direction Z. The hinge 26 may be provided to extend in the width direction Y, or a plurality of hinges may be provided along the width direction Y. The pressing member 25 is rotatably provided around the axis in the width direction Y by the hinge 26.

A pressing-member-side locking portion 28 that is formed to have a hook shape and protrudes toward the other side X2 of the fitting direction X in FIG. 1 is provided at a distal end of the pressing member 25. Meanwhile, the routing module case 10 of the routing module 1 is provided with a case-side locking portion 18 formed to have a concave shape. The case-side locking portion 18 has an opening formed therein and oriented toward one side Z1 of the height direction Z in the routing module case 10. The pressing-member-side locking portion 28 is locked into the case-side locking portion 18 by, for example, locking a jaw portion formed to have a hook shape into a protrusion (not illustrated) of the case-side locking portion 18 (refer to FIG. 2).

As described above, the connector 20 is fitted to the connector 110 of the monitoring device 100. The routing member W has a margin in a length from the outlet portion 12 to the connector 20 so as to enable the connector 20 to be reliably fitted to the connector 110 of the monitoring device 100. That is, as illustrated in FIG. 2, the routing member W has an extra length portion W1 (also refer to FIG. 1) which is longer than a distance L1 from the outlet portion 12 of the routing module case 10 to the connector 110 in a state in which the connector 20 is fitted to the connector 110 of the monitoring device 100. The extra length portion W1 is formed on one end side of the routing member W (side of the connector 20, one side X1 of the fitting direction X).

As illustrated in FIG. 2, when the connector 20 is fitted to the connector 110 of the monitoring device 100, the extra length portion W1 becomes a convex curve W1t indicated by a two-dot chain line on one end side of the routing member W. Since the routing member W made of an FPC or the like having a repulsive force against bending is fixed from one side Z1 of the height direction Z with respect to the housing 21 of the connector 20, the extra length portion W1 becomes the convex curve W1t protruding toward one side Z1 when the connectors 20 and 110 are fitted to each other.

With respect to the convex curve W1t of the extra length portion W1 formed in this manner, the pressing member 25 is rotatably moved to press the convex curve W1t on one end side of the routing member W. As a result, the convex curve W1t of the extra length portion W1 is pressed by the surface of the pressing member 25 on the other side Z2 of the height direction Z. Then, for example, even in a case in which a battery pack cover 30 provided on one side Z1 of the height direction Z in the battery module BM (battery pack BP) is provided close to the battery module BM (battery pack BP), interference between the convex curve W1t due to the extra length portion W1 and the battery pack cover 30 can be reduced.

In addition, when the pressing member 25 is located at a position at which the convex curve W1t is pressed by the pressing member 25, the pressing-member-side locking portion 28 can be locked into the case-side locking portion 18. That is, the pressing-member-side locking portion 28 is locked into the case-side locking portion 18 to maintain the pressing member 25 at a position in a direction in which the routing member W extends (in other words, the fitting direction X).

On the other hand, as illustrated in FIG. 1, the pressing member 25 can be located at a position at which the pressing member 25 is not in contact with the convex curve W1t. That is, the pressing member 25 is rotatably provided between a pressing position 25p (refer to FIG. 2) at which the convex curve W1t of the routing member W is pressed by the pressing member 25 and a release position 25s (refer to FIG. 1) at which the convex curve W1t of the routing member W is released.

The routing module 1 described above includes the routing member W electrically connected to the electrode terminals of the battery cells BC forming the battery module BM, the routing module case 10 having the routing path 11 formed for the routing member W to be provided therein, and the connector 20 including the housing 21 fixed from one side Z1 of the height direction Z which is a direction orthogonal to and intersecting the fitting direction X in which one end of the routing member W is fitted to the connector 110 of the monitoring device 100 serving as a mating connector, in which the routing member W extends toward one side Z1 of the housing 21, and the pressing member 25 is provided on one side Z1 of the housing 21 with the hinge 26 interposed between the pressing member 25 and the housing 21. The connector 20 includes the housing 21 in which one end of the routing member W is fixed to one side Z1 of the height direction Z, and the pressing member 25 provided on one side Z1 of the housing 21 with the hinge 26 interposed therebetween.

As a result, when the connector 20 to which the routing member W is fixed from one side Z1 of the height direction Z is fitted to the connector 110 of the monitoring device 100 which is a mating connector, the pressing member 25 rotatably provided by the hinge 26 is pressed against the convex curve W1t formed on the extra length portion W1 of the routing member W to press the convex curve W1t of the extra length portion W1, and the routing path of the extra length portion W1 of the routing member W can be restricted. In this way, the extra length portion W1 of the routing member W can be appropriately arranged. When the extra length portion W1 is appropriately arranged, interference between a member or a device around the battery pack BP (battery module BM), such as the battery pack cover 30, and the extra length portion W1 of the routing member W is reduced.

In addition, the pressing member 25 includes the pressing-member-side locking portion 28 that is locked into the case-side locking portion 18 provided in the routing module case 10 so as to maintain the pressing member 25 at a position in a direction in which the routing member W extends. As a result, since the position at which the pressing member 25 presses the convex curve W1t of the extra length portion W1 is maintained, the pressing member 25 does not easily release the convex curve W1t therefrom even if the battery pack BP mounted in the vehicle receives vibration.

The routing member W is routed along the fitting direction X in the routing path 11 of the routing module case 10, and the pressing member 25 is rotatably provided between the pressing position 25p at which the convex curve W1t on one end side of the routing member W is pressed by the pressing member 25 and the release position 25s at which the convex curve W1t of the routing member W is released from the pressing member 25. As a result, when the connector 20 is fitted to the connector 110 of the monitoring device 100, the pressing member 25 is located at the release position 25s and the path of the extra length portion W1 is not restricted, so that the work of fitting the connector 20 to the connector 110 of the monitoring device 100 can be facilitated. After the connector 20 is fitted thereto, the pressing member 25 can be located at the pressing position 25p to press the convex curve W1t of the extra length portion W1.

The pressing member 25 is formed to have a long rectangular plate shape elongated along a direction in which the routing member W extends, and the hinge 26 is formed to have a thin plate shape. As a result, the convex curve W1t of the extra length portion W1 can be pressed by the plate surface of the plate-shaped pressing member 25. Then, the hinge 26 can be formed with a simple configuration by the thin plate-shaped hinge 26 without using other members such as hinges.

Note that the routing module and the connector according to the embodiment of the present invention described above are not limited to the embodiment described above, and various modifications thereof can be made within the scope described in the claims.

In the above description, the pressing member 25 has a substantially long rectangular plate shape, but may have another shape such as a shape formed in a plate shape provided with a plurality of slits and net portions, or a shape formed of a plurality of bar-shaped members. In addition, the pressing-member-side locking portion 28 and the case-side locking portion 18 are locked with each other by concave-convex fitting in which the pressing-member-side locking portion 28 has a convex shape and the case-side locking portion 18 has a concave shape, but a relationship between the concave shape and the convex shape may be reversed, and locking in another form may be performed. The pressing member 25 presses (in other words, abuts on) the convex curve W1t of the extra length portion W1 of the routing member W and does not hold and fix the convex curve W1t, but may hold and fix the convex curve W1t. In this case, the routing member W can be moved in the direction in which the routing member W extends.

The routing module and the connector according to the present embodiment may be configured by appropriately combining the components of the embodiment and the modification described above.

A routing module and a connector according to the present embodiment have an effect that an extra length portion of a routing member can be appropriately arranged.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing module comprising:
a routing member electrically connected to an electrode terminal of a battery cell forming a battery module;
a routing module case having a routing path formed for the routing member to be provided therein; and
a connector including a housing fixed from one side of a direction intersecting a fitting direction in which one end of the routing member is fitted to a mating connector, wherein
the routing member extends toward the one side of the housing, and a pressing member is provided on the one side of the housing via a hinge.

2. The routing module according to claim 1, wherein
the pressing member includes a pressing-member-side locking portion locked into a case-side locking portion provided in the routing module case so as to maintain the pressing member at a position in a direction in which the routing member extends.

3. The routing module according to claim 1, wherein
the routing member is routed along the fitting direction in the routing path of the routing module case, and
the pressing member is rotatably provided between a pressing position allowing the pressing member to press a convex curve on the one end side of the routing member and a release position allowing the convex curve of the routing member to be released.

4. The routing module according to claim 2, wherein
the routing member is routed along the fitting direction in the routing path of the routing module case, and
the pressing member is rotatably provided between a pressing position allowing the pressing member to press a convex curve on the one end side of the routing member and a release position allowing the convex curve of the routing member to be released.

5. The routing module according to claim 1, wherein
the pressing member is formed to have a long rectangular plate shape elongated along a direction in which the routing member extends, and
the hinge is formed to have a thin plate shape.

6. A connector comprising:
a housing fixed to one side of a direction intersecting a fitting direction in which one end of a routing member electrically connected to an electrode terminal of a battery cell forming a battery module is fitted to a mating connector; and
a pressing member provided on the one side of the housing via a hinge.
